(19) United States
(12) Patent Application Publication
(10) Pub. No.: US 2026/0126916 A1
(43) Pub. Date: May 7, 2026

(54) EVENT LOG DATA STORAGE

(71) Applicant: Micron Technology, Inc., Boise, ID (US)

(72) Inventors: Senthil THANGARAJ, Fremont, CA (US); Andrew DANILOVIC, Collegeville, PA (US); Vishal TANNA, Milpitas, CA (US)

(21) Appl. No.: 19/332,831

(22) Filed: Sep. 18, 2025

Related U.S. Application Data
(60) Provisional application No. 63/715,319, filed on Nov. 1, 2024.

(51) Int. Cl. G06F 3/06

(52) U.S. Cl. CPC G06F 3/0616; G06F 3/0659; G06F 3/0673

(57) ABSTRACT

Implementations herein relate to a memory system that performs event log data storage. In some examples, the memory system may store the event log data in a non-volatile memory array, such as in a NOR non-volatile memory array. The memory system may store a first portion of the event log data including an indication of a time associated with an event and a sequence number of the event in a first set of contiguous memory blocks in the non-volatile memory array. The memory system may store a second portion of the event log data including debug data corresponding to the event in a second set of contiguous memory blocks in the non-volatile memory array.

Additionally, the memory system may store a third portion of the event log data including firmware record data associated with the event in a third set of contiguous memory blocks in the non-volatile memory array.

### CROSS-REFERENCE TO RELATED APPLICATION

This Patent Application claims priority to U.S. Provisional Ser. No. 63/715,319, filed on Nov. 1, 2024, entitled “EVENT LOG DATA STORAGE,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to event log data storage.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0 .” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIGS. 1 and 2 are diagrams illustrating example systems that are capable of event log data storage.

FIG. 3 is a diagram of an example memory system that is capable of event log data storage.

FIGS. 4 and 5 are diagrams of examples of event log data storage.

FIGS. 6 and 7 are diagrams of example processes related to event log data storage.

FIGS. 8 and 9 are flowcharts of example methods associated with event log data storage.

### DETAILED DESCRIPTION

Some memory systems may include firmware that plays a role in system stability and performance of the memory system by managing and logging events such as warnings, errors, and critical system states. The memory system may record and store event log data related to these events in a non-volatile memory array (e.g., a NOR non-volatile memory array), which may allow for offline diagnostic and root cause analysis if device failures occur.

Non-volatile NOR memory may be byte-level programmable and readable, and may be erasable in larger blocks (e.g., memory blocks, memory sectors, memory sub-sectors). Additionally, non-volatile NOR memory may be associated with a limited quantity of erase cycles before the wear (e.g., resulting from the erase cycles) leads to potential errors or data corruption within the non-volatile NOR memory. In some cases, a memory system may store event log data based on organizing the event log data into files within the non-volatile NOR memory array with specific start and end points and size indicators, which may facilitate a retrieval of the event log data by the memory system.

However, some techniques used to manage and write event log data to a NOR non-volatile memory array may increase a boot time of the memory system due to a slow process of mounting the event log data file from the NOR non-volatile memory array (e.g., transferring the event log data file from the NOR non-volatile memory array to a volatile memory array in the memory system). In some cases, the mounting time may become increasingly delayed as the size of the event log data file grows. Moreover, each time new data is added to the event log data file in the NOR non-volatile memory array, the memory system may erase the existing event log data within the NOR non-volatile memory array, and then rewrite the new and existing event log data to the NOR non-volatile memory array. This repeated erasure and rewriting may result in the memory system performing a large quantity of erase cycles on the NOR non-volatile memory array, which may quicken wear of NOR non-volatile memory array and increase a likelihood of data loss and corruption at the NOR non-volatile memory array.

Additionally, a memory system may be unable to quickly determine a latest event timestamp and sequence number based on the stored event log data. For example, a memory system may perform multiple scanning operations (e.g., on multiple event log data files) to determine a latest event timestamp and sequence number. Furthermore, some event log data storage systems may not include adequate data integrity protection or tracking of erase cycle counts, which may result in undetectable corruption of the data stored in the NOR non-volatile memory array. Additionally, some events associated with large event log data files (e.g., that include large amounts of debug data) may overwhelm the event log data files stored in the NOR non-volatile memory array and displace potentially critical events that have smaller event log data files (e.g., that include smaller amounts of debug data). These limitations may decrease the effectiveness of event log data storage and management, which may decrease the reliability of data stored by the memory system.

In accordance with techniques described herein, a memory system may detect events associated with operations and organize event log data into various sets of contiguous memory blocks in a NOR non-volatile memory array, including separate blocks for storing event times and sequence numbers, debug data, and firmware record data associated with the events. The memory system may identify and write data to the next available address within the NOR non-volatile memory array without reading and transferring the entire event log data file to a volatile memory array and without erasing the existing data from the NOR non-volatile memory array prior to writing new data to the NOR non-volatile memory array. For example, the memory system may use memory block headers and footers for organization and mounting, which may reduce operational latency and conserve processing resources associated with other event log data storage techniques. The avoidance of unnecessary erase cycles may extend the lifespan of the NOR non-volatile memory array.

To store data in the NOR non-volatile memory array, the memory system may employ a writing sequence that includes writing an event header first, followed by writing the event data itself, then finalizing with writing an event footer. This method ensures that, in the event of a sudden power cycle, the integrity of the write operation can be verified (e.g., by determining whether the write operation for the data has been completed and the event footer has been written to the NOR non-volatile memory array), thereby improving data reliability and enhancing the technical robustness of the memory system. In some cases, the memory system may additionally increase an efficiency of storing event log data by storing new debug data only when it differs from previously stored debug data (e.g., and refraining from storing redundant debug data).

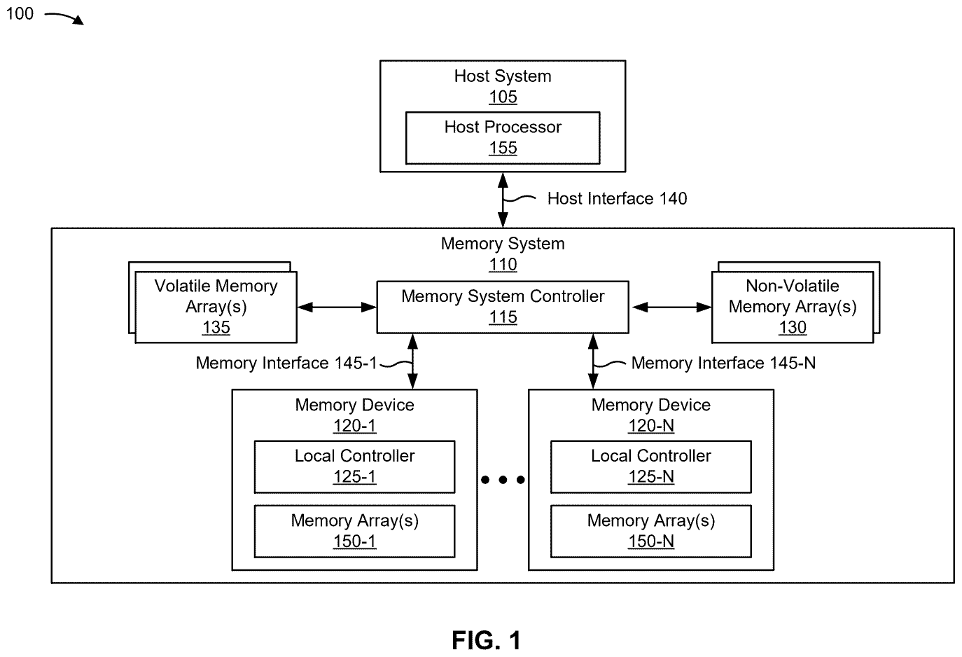

FIG. 1 is a diagram illustrating an example system 100 capable of event log data storage. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 150. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 155. The host processor 155 may include one or more processors configured to execute instructions and store data in the memory system 110. For example, the host processor 155 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 150. In some implementations, a memory device 120 includes a single memory array 150. In some implementations, each memory device 120 of the memory system 110 may be implemented in a separate semiconductor package or on a separate die that includes a respective local controller 125 and a respective memory array 150 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 150 coupled with the local controller 125 based on one or more instructions from the memory system controller 115. As an example, the memory system controller 115 may be an SSD controller, and the local controller 125 may be a NAND controller.

A memory array 150 may include an array of memory cells configured to store data. For example, a memory array 150 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory (e.g., a non-volatile memory array 130) capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to a non-volatile memory array 130, and/or may cache instructions to be executed by a controller of the memory system 110.

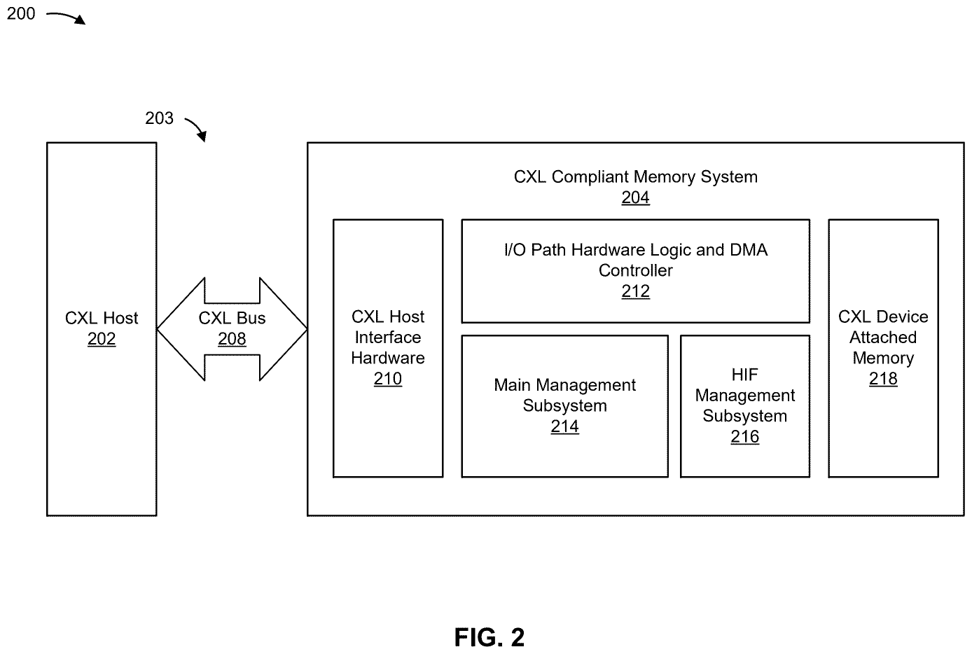

The host interface 140 enables communication between the host system 105 (e.g., the host processor 155) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 150), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 150) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 150). In some implementations, the controller may translate a host interface command (e.g., a command received from the host system 105) into a memory interface command (e.g., a command for performing an operation on a memory array 150).

The memory system 110 may store event log data in a non-volatile memory array 130. The event log data may include event records associated with vendor specific debug events that are detected by a firmware of the memory system 110 (e.g., that may be implemented by the memory system controller 115). The memory system 110 may rely on the event log data for diagnostic analysis purposes. In some memory systems, a non-volatile memory array 130 may store the event log data within files, and each file may have a set of parameters. For example, each file of event log data may include a read pointer (e.g., that points to a start of the oldest event log data in the file), a write pointer (e.g., that points to a next available address to write new event log data to), a size parameter (e.g., indicating an amount of event log data currently within the file), and a parameter indicating a quantity of event records currently saved in the file.

The event log data files may store one or more event records (e.g., including firmware vendor specific event record data). In one example, the event record may be formatted to be a variable size, provide up to four double word (DWORD) parameters, and optionally include event specific data (e.g., if additional context for the event is needed). One example of the event specific data may include device hardware registers that indicate a state of a device (e.g., a memory device 120, the memory system 110, another device included in or coupled to the memory system 110). The event records may additionally include an event record identifier that uniquely identifies the event record (e.g., a firmware event record identifier), an indication of a time associated with the event (e.g., a firmware event record timestamp), and a sequence number associated with the event that may correspond to an event record counter (e.g., a firmware event record sequence number).

The memory system 110 may store the event records in files that are associated with a type of the event. For example, the non-volatile memory array 130 may include a first set of contiguous memory blocks configured to store event records associated with warning events (e.g., a firmware warning event log data file), a second set of contiguous memory blocks configured to store event records associated with error events (e.g., a firmware error event log), and a third set of contiguous memory blocks configured to store event records associated with critical events (e.g., a firmware critical event log). In this scheme, when a firmware event occurs (e.g., a firmware warning event, a firmware error event, or a firmware critical event), the firmware of the memory system 110 may collect internal diagnostic data (e.g., up to 64 kilobytes (KB) of internal diagnostic data) from hardware and/or firmware debug data sources within the memory system 110, and save the collected internal diagnostic data within an event record (e.g., within a vendor specific event record). The memory system 110 may save the event record within a file in the non-volatile memory array 130. In some cases, a hardware debug data source may include a hardware host transaction logger, a hardware error logger, or a hardware register. Additionally, a firmware debug data source may include a central processing unit (CPU) data memory or one or more CPU registers.

In some examples, the non-volatile memory arrays 150 may include one or more NOR non-volatile memory arrays. The NOR non-volatile memory arrays may be byte programmable. That is, the memory system 110 may write new data to the NOR non-volatile memory arrays one byte at a time. Additionally, the NOR non-volatile memory arrays may be byte readable. That is, the memory system 110 may read data stored in the NOR non-volatile memory arrays one byte at a time. Further, the NOR non-volatile memory arrays may be sector or sub-sector erasable. That is, the data stored in a NOR non-volatile memory array may erase a memory block (e.g., a sector or a sub-sector) at a time. For example, the memory system 110 may erase data according to a sector or sub-sector granularity (e.g., 64 KB, 32 KB, 4 KB).

The memory system 110 may erase data from the NOR non-volatile memory array prior to writing more data to the NOR non-volatile memory array. For example, the memory system 110 may erase the data from a memory block in the NOR non-volatile memory array prior to writing any new data to the memory block. Accordingly, the memory system 110 may perform erase operations on the NOR non-volatile memory array in response to identifying new event log data to store in the NOR non-volatile memory array. However, the NOR non-volatile memory array may only support a certain quantity of erase operations within a lifetime of the NOR non-volatile memory array. That is, after the quantity of erase operations is exceeded, the NOR non-volatile memory array may be unable to store data reliably. For example, a NOR non-volatile memory array may support up to 100,000 erase cycles within the lifetime of the NOR non-volatile memory array. Additionally, a time associated with performing an erase operation may be greater than a time associated with performing a program (e.g., a write) operation or a read operation. Accordingly, if the memory system 110 decreases a quantity of erase operations performed on a NOR non-volatile memory array that stores event log data, the memory system 110 may increase a lifespan of the NOR non-volatile memory array and decrease a latency associated with event log data storage.

During a mount operation, the memory system 110 may transfer the event log data from a NOR non-volatile memory array (e.g., such as from a non-volatile memory array 130 that includes NOR memory) to a volatile memory array 135. The memory system 110 may perform the mount operation during a power on sequence of the memory system. For example, if the memory system 110 is a CXL compliant memory system 110, the memory system 110 may perform the mount operation as part of a CXL device power on sequence. The mount operation may enable the memory system 110 to recover the log file parameters (e.g., within the event log data) prior to saving new event records to the event log data file. To perform the mount operation, the memory system 110 may read an event log header from the NOR non-volatile memory array to determine a size of the log file. That is, the event log header may include the read pointer, the write pointer, a size parameter, and a parameter indicating the quantity of event records included in the log file. Based on the information in the event log header, the memory system 110 may read the entire event log data file from the NOR non-volatile memory array to the volatile memory array 135.

Additionally, the mount operation may enable the memory system 110 to load the event records to the volatile memory array 135 (e.g., to a RAM memory array) for subsequent read operations on the event records. That is, the memory system 110 may serve read operations for the event log data from the volatile memory array 135 (e.g., instead of from the non-volatile memory array 130).

In some cases, when a warning event, error event, or critical event occurs, the memory system 110 (a firmware associated with the memory system 110) may create and save an event record. That is, the memory system 110 may create an event record and perform a write operation to store the event record in the NOR non-volatile memory array. In particular, in response to detecting an event (e.g., a warning event, error event, or critical event), the memory system may collect debug data (e.g., from the internal device hardware and/or firmware debug data sources) and create a new event record (e.g., a new vendor specific event record). Then, the memory system 110 may save the new event record to the volatile memory array 135 (e.g., to RAM). The volatile memory array 135 may include a ring buffer. In such cases, the memory system 110 may first determine whether a ring buffer wrap is to occur in response to saving the new event record to the volatile memory array 135. If the ring buffer wrap does occur, the memory system 110 may overwrite the oldest event record with the new event record data. Then the memory system 110 may update the event log header information within the volatile memory array 135. For example, the memory system 110 may update the read pointer, write pointer, size parameter, and parameter indicating the quantity of event records in the file within the volatile memory array 135. Then, the memory system 110 may erase the entire log file (e.g., the critical event file, the warning event file, the error event file) from the NOR non-volatile memory array and write the contents from the volatile memory array 135 (e.g., the corresponding file including the new event record) to the NOR non-volatile memory array. For example, if the new event record is associated with a critical event, the memory system 110 may erase the entire critical event file from the NOR non-volatile memory array, and write the critical event file stored in the volatile memory array 135 (e.g., that includes the new event record) to the NOR non-volatile memory array.

Such techniques for event log storage may be associated with resource inefficiencies, increased latencies, excess erase operations, a lack of data integrity protection, and other shortcomings. For example, because the memory system 110 erases the entire content of a log file from the NOR non-volatile memory array prior to performing a write operation (e.g., which may occur each time new event log data is written), the lifespan of the NOR non-volatile memory array may be limited (e.g., due to the large quantity of erase operations). Additionally, the erase operations may be associated with more latency (e.g., as compared to a latency associated with other access operations), which may in turn introduce latency to write operations associated with the event log data storage. In some cases, the latency may also increase as the size of the log file increases. Additionally, mounting the entire file from the NOR non-volatile memory array to the volatile memory array 135 may be time consuming (and may increase in time consumption as the size of the file increases) and resource inefficient (e.g., a large amount of volatile memory may be required in the volatile memory array 135). Further, the integrity of the log data may not be protected. That is, if the memory system 110 loses power during a write operation (e.g., while the memory system 110 is writing the event log data to the NOR non-volatile memory array), any data not already written to the NOR non-volatile memory array may be lost. Additionally, because the memory system 110 erases the entire content of a log file from the NOR non-volatile memory array prior to performing a write operation of new data, older (but still valid) data which was previously successfully written to the NOR non-volatile memory array may be lost if the memory system 110 loses power during the write operation to save new data.

Additionally, the event log data may not be protected by any error detection or correction information (e.g., such as cyclic redundancy check information and/or checksum information). Accordingly, errors within the event log data may be undetectable or uncorrectable. Further, a quantity of erase cycles performed at the NOR non-volatile memory array is not tracked. Accordingly, the quantity of erase cycles performed at the NOR non-volatile memory array may be greater than a threshold associated with the NOR non-volatile memory array being capable of reliably storing data, and the memory system 110 may be unaware and continue storing data at the NOR non-volatile memory array. This may cause the NOR non-volatile memory array to introduce errors into the stored event log data stored. Additionally, some events may be associated with larger log files (e.g., due to being associated with larger amounts of debug data) compared to a size of log files for other events. Here, the event log data file may contain a large amount of data associated with the event, which may cause data associated with an event that is associated with smaller log files (e.g., due to having smaller amounts of debug data) to be flooded out of the log file.

Additionally, an amount of time associated with identifying a global sequence number associated with a most recently occurring event may increase as a size of the log files grows. That is, the firmware of the memory system 110 may scan all of the files stored in the NOR non-volatile memory array and all of the event records within each file to identify the latest event sequence number and corresponding timestamp. In some cases, the memory system 110 may globally order event records during a diagnostic analysis to identify a root cause of a device failure. To do so, the firmware of the memory system 110 may assign monotonically increasing event sequence numbers and time stamps to new event records, which may enable the firmware to identify an order of the events. In cases where the events are organized into different files (e.g., such as into warning event log data files, error event log data files, and critical event log data files), the memory system 110 may mount each of the files and scan through each of the event records to identify the global sequence number of the most recently occurring event and associated timestamp, which may be a time consuming process.

In the example system 100, the memory system 110 may implement different techniques for event log data storage to improve resource efficiency, reduce latencies, reduce a quantity of erase operations, and improve data integrity protection. For example, the memory system 110 may store the sequence numbers and event times associated with detected events (e.g., detected warning events, detected error events, and detected critical events) in a single set of contiguous memory blocks. Accordingly, the memory system 110 may perform a single mount operation of the single set of contiguous memory blocks to identify the global sequence number associated with the most recently occurring event, which may be associated with decreased latency as compared to the memory system 110 mounting all of the event log data from the NOR non-volatile memory array to identify the global sequence number associated with the most recently occurring event. Further, the memory system 110 may reduce a quantity of erase operations on the NOR non-volatile memory array by not erasing and rewriting data to the NOR non-volatile memory array multiple times, and instead only erasing data from the NOR non-volatile memory array when a file in the NOR non-volatile memory array is full (e.g., when the oldest event log data is erased to make room for new event log data).

Additionally, the memory system 110 may include headers and footers for each set of event log data (e.g., each data segment stored by the NOR non-volatile memory array). The headers and footers may include some error detection or correction information, which may improve the data integrity of the event log data. Additionally, the memory system 110 may mount the headers and the footers for the event log data, rather than the entire event log data, which may further decrease a latency associated with performing access operations associated with the event log data. Additionally, by saving debug data corresponding to specific events to separate log files, events with large associated debug data will be less likely to flood out events with small or no associated debug data.

In some implementations, one or more systems, devices, apparatuses, components, and/or controllers of FIG. 1 may be configured to detect an event associated with an operation of the memory system; store, within a first set of contiguous memory blocks in a NOR non-volatile memory array, first log data comprising an indication of a time associated with the event and an indication of a sequence number associated with the event; store, within a second set of contiguous memory blocks in the NOR non-volatile memory array, second log data comprising debug data corresponding to the event; and store, within a third set of contiguous memory blocks in the NOR non-volatile memory array, third log data comprising firmware record data associated with the event.

In some implementations, one or more systems, devices, apparatuses, components, and/or controllers of FIG. 1 may be configured to transfer, from a NOR non-volatile memory array comprising a plurality of memory blocks configured to store log data to a volatile memory array, one or more memory block headers and one or more memory block footers; identify a first memory block comprising a next available address for new data to be stored in the NOR non-volatile memory array based at least in part on the first memory block comprising a valid memory block header and an invalid memory block footer; transfer, from the first memory block to the volatile memory array, one or more data segment headers and one or more data segment footers based at least in part on identifying that the first memory block comprises the next available address; and identify the next available address based at least in part on a last data segment footer within the one or more data segment footers stored within the first memory block.

In some implementations, one or more systems, devices, apparatuses, components, and/or controllers of FIG. 1 may correspond to a memory system that comprises a controller configured to detect a plurality of events associated with an operation of the memory system; and a NOR non-volatile memory array coupled to the controller and comprising: a first set of contiguous memory blocks configured to store first log data comprising indications of times associated with each of the plurality of events and sequence numbers associated with each of the plurality of events.

The number and arrangement of components shown in FIG. 1 are provided as an example. In practice, there may be additional components, fewer components, different components, or differently arranged components than those shown in FIG. 1.

Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of event log data storage. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 150) and a CXL interface (e.g., the CXL bus 208). In some examples, the CXL memory system controller may be configured to handle one or more CXL protocol layers, such as an I/O layer (e.g., a layer associated with a CXL. io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL. cache protocol, which may be used for purposes such as caching host memory using a modified, exclusive, shared, invalid (MESI) coherence protocol, or similar purposes); or a memory protocol layer (e.g., a layer associated with a CXL. memory (sometimes referred to as CXL. mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3device may be a memory expander device.

The number and arrangement of components shown in FIG. 2 are provided as an example. In practice, there may be additional components, fewer components, different components, or differently arranged components than those shown in FIG. 2.

Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

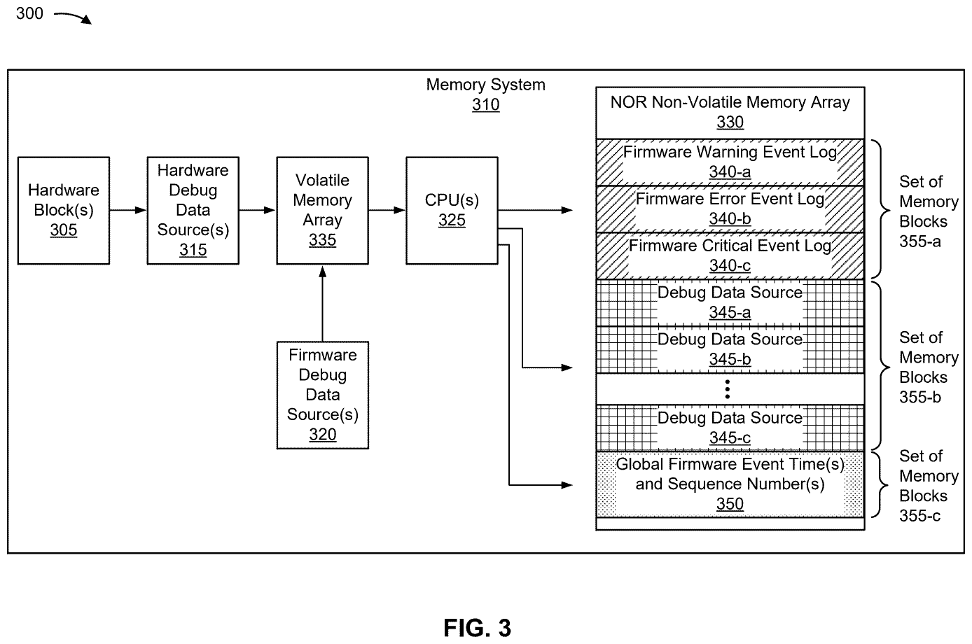

FIG. 3 is a diagram of an example 300 memory system 310 that is capable of event log data storage. In some cases, the example 300 may include aspects of systems, devices, or components described with reference to FIGS. 1 and 2. For example, the memory system 310 may include aspects of the memory system 110 or the CXL compliant memory system 204; the CPU(s) 325 may include aspects of the memory system controller 115, the local controller 125, or the CXL memory system controller described with reference to FIG. 2; the NOR non-volatile memory array 330 may include aspects of the non-volatile memory arrays 130; and the volatile memory array 335 may include aspects of the memory array(s) 135.

The memory system 310 may include one or more hardware blocks 305, one or more hardware debug data sources 315, one or more firmware debug data sources 320, a volatile memory array 335, one or more CPUs 325, and a NOR non-volatile memory array 330. The hardware blocks 305 may include one or more interfaces (e.g., a PCIe interface, a CXL interface), circuitry in the memory system 310 (e.g., a memory and logic circuitry, error detection or correction circuitry), or one or more memory components (e.g., a cache, a buffer, a memory array, a memory device). The one or more hardware debug data sources 315 may include a hardware host transaction logger, a hardware error logger, or one or more hardware registers. The one or more firmware debug data sources 320 may include the one or more CPUs 325 or one or more CPU registers.

The hardware debug data sources 315 and the firmware debug data sources 320 may provide data (e.g., debug data) to the volatile memory array 335 directly. For example, a firmware managed direct memory access operation may enable the hardware debug data sources 315 and the firmware debug data sources 320 to provide the data directly to the volatile memory array 335. The volatile memory array 335 may collect the debug data from the hardware debug data sources 315 and the firmware debug data sources 320 and store the debug data in volatile memory buffers. In some cases, the volatile memory array 335 may include RAM. The volatile memory array 335 may provide an event record staging buffer for the memory system 310. For example, the memory system 310 may detect an event (e.g., a warning event, an error event, a critical event) at the memory system 310, and the hardware debug data sources 315 and/or the firmware debug data sources may provide log data related to the event to the volatile memory array 335 (e.g., via a firmware managed direct memory access operation).

The one or more CPUs 325 may store the log data in the NOR non-volatile memory array 330. The CPUs 325 may store subsets of the log data within different sets of memory blocks 355 in the NOR non-volatile memory array 330. In some cases, the sets of memory blocks 355 may each include one or more contiguous memory blocks. In some cases, the memory blocks may correspond to memory sectors or memory sub-sectors within the NOR non-volatile memory array 330. For example, the CPUs 325 may store a first subset of the log data including the firmware record data associated with the event (e.g., the firmware vendor specific event record data) within a first set of the memory blocks 355-a, a second subset of the log data including the debug data associated with the event (e.g., the debug event record data) in the second set of memory blocks 355-b, and third subset of the log data including an indication of a time and sequence number associated with the event (e.g., a timestamp and global sequence number) in the third set of memory blocks 355-c.

The set of memory blocks 355-a that is configured to store the firmware record data may include multiple subsets of memory blocks (e.g., of contiguous memory blocks within the set of memory blocks 355-a) that store firmware record data associated with different types of events. For example, a first subset of one or more memory blocks may be configured to store a firmware warning event log 340-a, which may include log data associated with warning events; a second subset of one or more memory blocks may be configured to store a firmware error event log 340-b, which may include log data associated with error events; and a third subset of one or more memory blocks may be configured to store a firmware critical event log 340-c, which may include log data associated with critical events.

The firmware record data associated with an event may include a firmware event record identifier, an indication of a quantity of DWORD parameters included in the firmware record data associated with the event, one or more optional DWORD parameters, a debug data source identifier, and a debug data sequence number. The firmware event record identifier may uniquely identify the corresponding event. In some cases, the firmware event record identifier may include 2 bytes of information.

The indication of the quantity of DWORD parameters may indicate the quantity of the one or more optional DWORD parameters included in the firmware record data associated with the event. For example, the firmware record data associated with the event may include three DWORD parameters, and the indication of the quantity of DWORD parameters may indicate that the firmware record data associated with the event includes three DWORD parameters. In some cases, the indication of the quantity of DWORD parameters may include one byte of information, and each of the DWORD parameters may include zero to four bytes of information. The debug data source identifier may point to one of the debug data sources 345, which may include additional contextual information associated with the event that the memory system 310 collects and saves in the set of memory blocks 355-b in response to detecting the event. In some cases, the debug data source identifier may include two bytes of information. The debug data sequence number may be a pointer to a specific event within the event specific log file. For example, the debug data sequence number in the firmware record data associated with an event may also be included in the debug data stored in the set of memory blocks 355-b associated with the event. In some cases, the debug data sequence number may include four bytes of information.

The set of memory blocks 355-b may be configured to store debug data associated with one or more events. For example, the set of memory blocks 355-b may be storing debug data source 345-a, debug data source 345-b, and debug data source 345-c. Each debug data source 345 may include a debug data source identifier, a debug data sequence number, an indication of a size of the debug data included in the debug data source 345, and the debug data associated with one or more detected events. The debug data source identifier may uniquely identify the debug data source. For example, the debug data source identifier may identify one of the hardware debug data sources 315, one of the firmware debug data sources 320, or another debug data source. The debug data source identifier may be a same debug data source identifier included in the firmware record data (e.g., stored in the set of memory blocks 355-a) associated with the event. In some cases, the debug data source identifier in the firmware record data being the same as the debug data source identifier in the debug data source 345 may be a pointer from the firmware record data to the debug data source 345 associated with the same event. The debug data sequence number may correspond to a global sequence number, that may be a same global sequence number across all events in all log files that have a same set of debug data. For example, some events may occur more than once, and may be associated with the same set of debug data. For instance, an event may occur more than once sequentially, and the debug data collected by the memory system 310 in response to detecting the event may be unchanged between the multiple occurrences in the event. Here, the firmware record data associated with the multiple events may each have the same debug data sequence number that corresponds to the same debug data source 345. The indication of the size of the debug data may include two bytes of information that indicates the size of the debug data included in the debug data source 345, which may include up to 64 bytes of information.

The set of memory blocks 355-c may be configured to store the indications of the times associated with detected events and the indications of the sequence numbers associated with the events. For example, the set of memory blocks 355-c may store the global firmware event times (e.g., timestamps) and sequence numbers 350. In some cases, the sequence numbers may correspond to global sequence numbers that indicate a sequence of the detected events. For example, a first event that is detected may be associated with a sequence number of ‘1’, and the next event that is detected may have a sequence number of ‘2.’ The indication of the time associated with a detected event may include eight bytes of information, and the sequence number associated with an event may include up to four bytes of information.

In some cases, the memory system 310 may identify the time and sequence number associated with a most recently occurring event that was detected by the memory system 310 (e.g., as part of a diagnostic analysis operation to identify a root cause of a device failure). Here, the memory system 310 may mount the global firmware event times and sequence numbers 350 from the set of memory blocks 355-c in the NOR non-volatile memory array 330 to the volatile memory array 335. That is, the memory system 310 may only mount a subset of the log data from the NOR non-volatile memory array 330 to identify the most recently occurring event (e.g., which may correspond to the event associated with the largest sequence number and the event associated with the most recent timestamp). By refraining from mounting one or more other subsets of the NOR non-volatile memory array 330 (e.g., the firmware record data stored in the set of memory blocks 355-a and the debug data sources 345 stored in the memory blocks 355-b) when identifying the global sequence number of the most recent event, the memory system 310 may decrease a latency associated with identifying a next global event sequence number to use for future events such that future events are correctly globally ordered relative to previous events.

As indicated above, FIG. 3 is provided as an example. Other examples may differ from what is described with regard to FIG. 3.

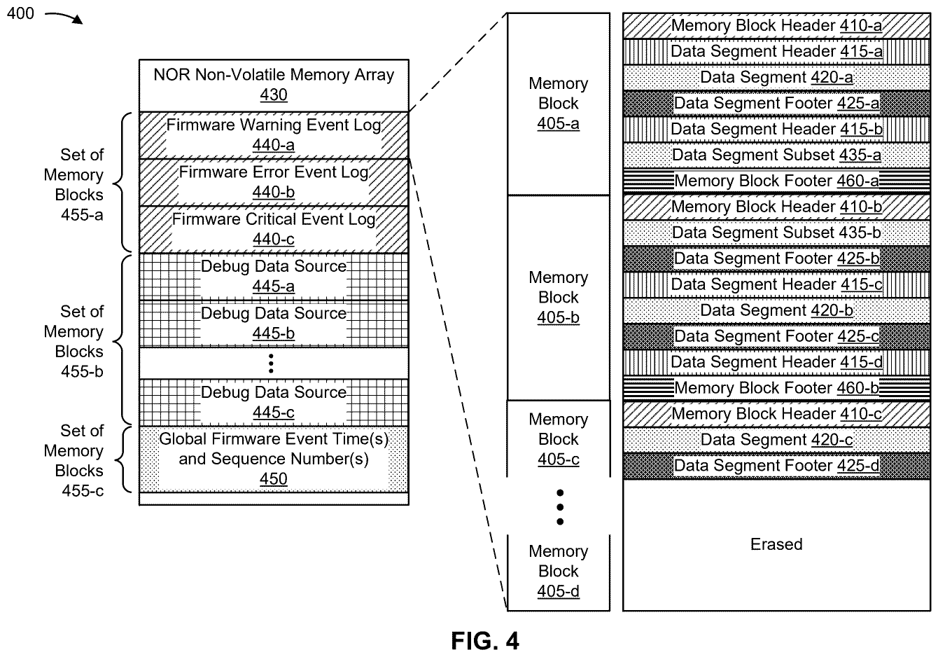

FIG. 4 is a diagram of an example 400 of event log data storage. The operations described in connection with FIG. 4 may be performed by a memory system (such as the memory system 110, the CXL compliant memory system 204, the memory system 310) and/or one or more components of the memory system, such as the memory system controller 115, one or more memory devices 120, the one or more local controllers 125, and/or the one or more CPUs 325.

The example 400 illustrates a NOR non-volatile memory array 430, which may be an example of the NOR non-volatile memory array 330 described with reference to FIG. 3. A memory system may use the NOR non-volatile memory array 430 to store event log data. For example, the memory system may store a first subset of the log data including the firmware record data associated with the event (e.g., the firmware vendor specific event record data) within a first set of the memory blocks 455-a, a second subset of the log data including the debug data sources 445 associated with the event (e.g., the debug event record data) in the second set of memory blocks 455-b, and third subset of the log data including global firmware event times and sequence numbers 450 in the third set of memory blocks 455-c. In some cases, the set of memory blocks 455-a that is configured to store the firmware record data may include multiple subsets of memory blocks (e.g., of contiguous memory blocks within the set of memory blocks 455-a) that store firmware record data associated with different types of events. For example, a first subset of one or more memory blocks may be configured to store a firmware warning event log 440-a, a second subset of one or more memory blocks may be configured to store a firmware error event log 440-b, and a third subset of one or more memory blocks may be configured to store a firmware critical event log 440-c, which may include log data associated with critical events.

Each set of memory blocks 455 may be configured to store one or more log files. For example, the set of memory blocks 455-a may store three log files: the firmware warning event log 440-a file, the firmware error event log 440-b file, and the firmware critical event log 440-c file. The set of memory blocks 455-b may store a debug data file, which may include one or more debug data sources 445. Additionally, the set of memory blocks 455-c may store the global firmware event times and sequence numbers 450 file. Each of the files may be associated with an indication of an oldest memory block 405 in the file (e.g., as indicated by an oldest block index), an indication of a currently open memory block 405 (e.g., as indicated by a currently open block index), and an indication of a next available address (e.g., as indicated by a current open block offset). In the example 400, the oldest block index may point to the memory block 405-a, the currently open block index may point to the memory block 405-c, and the current open block offset may point to an address that is directly following the data segment footer 425-d.

The memory blocks 405 in the set of memory blocks 455 may each include a memory block header 410 and a memory block footer 460. When the memory system opens a new memory block 405 within the set of memory blocks 455 (e.g., to write data to the memory block 405), the memory system may write the memory block header 410 to the memory block 405. That is, a memory block 405 that includes valid data may include a valid memory block header 410. Additionally, a memory block 405 that does not include a valid memory block header 410 may not include any valid data. Additionally, when a memory system closes a memory block 405, the memory system may write the memory block footer 460 to the memory block 405. Accordingly, memory blocks 405 that include a valid memory block header 410 and a valid memory block footer 460 may be full (e.g., and closed) of valid data. Additionally, a memory block 405 that includes a valid memory block header 410 and does not include a valid memory block footer 460 may include a next available address for storing data within the set of memory blocks 455. For example, the memory block 405-c may include a valid memory block header 410-c, and may not include a valid memory block footer 460. Accordingly, new event log data may be written to a next available address within the memory block 405-c.

The memory block headers 410 may include a memory block header signature, a memory block metadata sequence number, an offset indication, an indication of a quantity of erase operations performed on the memory block 405, one or more reserved bytes, and error detection information associated with the memory block header 410. The memory block header signature may include a quantity of bytes (e.g., four bytes) that correspond to a signature that identifies the associated memory block 405.

The memory block metadata sequence number may include a quantity of bytes (e.g., four bytes) that identifies an order associated with each of the memory blocks 405 in a set of memory blocks 455. That is, the memory block metadata sequence number may identify a memory block 405 in the set of memory blocks 455 that includes a next available address for storing data. In the example 400, the memory block metadata sequence number in the memory block header 410-c associated with the memory block 405-c may indicate that the memory block 405-c includes the next available address for storing data. In some cases, the memory block metadata sequence number in the memory block header 410-c may indicate a larger (e.g., a more recent) sequence number than the memory block metadata sequence numbers in the memory block headers 410-a and 410-b, which may in turn indicate that the memory block 405-c includes the next available address for storing data.

The offset indication within the memory block header 410 may indicate a next available address in the memory block 405. In particular, the offset indication may indicate an offset of a start of a first valid data segment 420 (e.g., a first valid event) in the memory block 405. The memory system may perform read operations on the memory block 405 based on the offset indication. In particular, the memory system may determine the offset of the first valid data segment 420 within the memory block 405, which may be adjusted when the data segment 420 has been written to the memory block 405 after a ring buffer wrap.

The indication of the quantity of erase operations performed on the memory block 405 may include a quantity of bytes (e.g., three bytes) indicative of the quantity of erase operations. The memory system may increment the indication in response to performing an erase operation (e.g., and subsequent write operation) on the memory block 405. In some cases, if a quantity of erase operations indicated by this indication exceeds a threshold quantity, the memory system may determine that the memory block 405 is no longer capable of storing data reliably.

The error detection information associated with the memory block header 410 may include one or more bits of error detection and/or correction information associated with the data within the memory block header 410. For example, the error detection information may include a quantity (e.g., two) bytes of cyclic redundancy check information over the bytes of information within the memory block header 410.

The memory block footer 460 may include one or more bytes of information that summarizes a remaining portion of the data within the memory block 405. For example, the memory block footer 460 may include a memory block footer signature, an offset indication, an indication of an amount of user data (e.g., of non-metadata) stored in the memory block 405, and error detection information associated with the memory block footer 460. The memory block footer signature may include a quantity of bytes (e.g., four bytes) that correspond to a signature that identifies the associated memory block 405. The offset indication within the memory block footer 460 may indicate last valid data segment 420 (e.g., a last valid event) within the memory block 405. For example, the offset indication within the memory block footer 460-a may indicate an offset within the memory block 405 of the data segment subset 435-a (e.g., the last valid event stored within the memory block 405-a).

The indication of the amount of user data stored in the memory block 405 may include a quantity of bytes (e.g., two bytes) that indicates a total size (e.g., in bytes) of user data in the memory block 405. The memory system may rely on the data stored in the indication of the amount of user data stored in the memory block 405 during a ring buffer wrap sequence (e.g., to subtract a total user file size). In some cases, if a last data segment 420 within a memory block 405 includes any data (e.g., a data segment subset 435) that spans into a next memory block 405, the indication of the amount of user data stored in the memory block 405 (e.g., that is included in the memory block footer 460) may only indicate the data segment subset 435 that is stored in that memory block 405 (e.g., and not indicate the data segment subset 435 that is stored in a subsequent memory block 405). For example, a data segment may be split into a first data segment subset 435-a stored in the memory block 405-a and a second data segment subset 435-b (e.g., in cases that the entire data segment is unable to be stored in a remaining amount of space in the memory block 405-a). Here, the memory block footer 460-a in the memory block 405 may indicate that the memory block 405-a is storing an amount of user data corresponding to the data segment 420-a and the data segment subset 435-a (e.g., instead of the entire data segment including the data segment subset 435-a and the data segment subset 435-b).

The error detection information associated with the memory block footer 460 may include one or more bits of error detection and/or correction information associated with the data within the memory block footer 460. For example, the error detection information may include a quantity (e.g., two) bytes of cyclic redundancy check information over the bytes of information within the memory block footer 460.

The NOR non-volatile memory array 430 may be configured to store data segments 420, which may include event log data associated with an event. For example, the data segments 420 stored in the first set of memory blocks 455-a may include firmware record data associated with an event, the data segments 420 stored in the second set of memory blocks 455-b may include debug data associated with an event, and the data segments 420 stored in the third set of memory blocks 455-c may include an indication of a time (e.g., a timestamp) and an indication of a sequence number associated with an event. The memory system may additionally store a data segment header 415 and a data segment footer 425 associated with each data segment. For example, when the memory system writes new data to a log file (e.g., to one of the sets of memory blocks 455), the memory system may write a data segment header 415, a data segment 420, and a data segment footer 425.

The data segment headers 415 may include an event header signature, a global sequence number associated with an event, an indication of a size of the associated data segment 420, first error detection information associated with the data segment header 415 and the associated data segment 420, and second error detection information associated with the data segment header 415 (e.g., and not associated with the data segment 420). The event header signature may include a quantity of bytes (e.g., four bytes) that corresponds to a signature that identifies the data segment header 415. The global sequence number associated with the event may include a quantity of bytes (e.g., four bytes) that uniquely identifies the event, and may be a same global sequence number across multiple log files. The indication of the size of the associated data segment 420 may include a quantity of bytes (e.g., two bytes) that indicates a size of the event record included in the associated data segment 420. The first error detection information may include one or more bytes of error detection and/or correction information (e.g., two bytes of cyclic redundancy check information) over the data segment header 415 and the associated data segment 420. The second error detection information may include one or more bytes of error detection and/or correction information (e.g., two bytes of cyclic redundancy check information) over the data segment header 415 (and not over the data segment 420).

The data segment footers 425 may include an event footer signature, an indication of a size of the user data currently stored in the set of memory blocks 455 (e.g., a size of all of the user data in the associated log file), an indication of a time associated with the event, and error detection information associated with the data segment footer 425 (e.g., and not associated with the data segment 420). The event footer signature may include a quantity of bytes (e.g., four bytes) that corresponds to a signature that identifies the data segment footer 425. The indication of the size of the user data currently stored in the set of memory blocks 455 may include one or more bytes (e.g., four bytes) that indicate a total size (e.g., in bytes) of all of the user data currently stored in the log file that is stored in the set of memory blocks 455 that includes the data segment footer 425. In some cases, the last data segment footer 425 in a log file (e.g., the most recently written data segment footer 425) may include the indication of the current size of the log file, while a remaining quantity of the data segment footers 425 may include outdated indications of the log file size. The indication of the time associated with the event may include one or more bytes (e.g., eight bytes) that indicates a same time as indicated in other log files. For example, the data segment footer 425 for an event may indicate the same time of the event as is indicated in the global firmware event times and sequence numbers 450 log file. The error detection information in the data segment footers 425 may include one or more bytes of error detection and/or correction information (e.g., two bytes of cyclic redundancy check information) over the data segment footers 425 (and not over the data segments 420).

As indicated above, FIG. 4 is provided as an example. Other examples may differ from what is described with regard to FIG. 4.

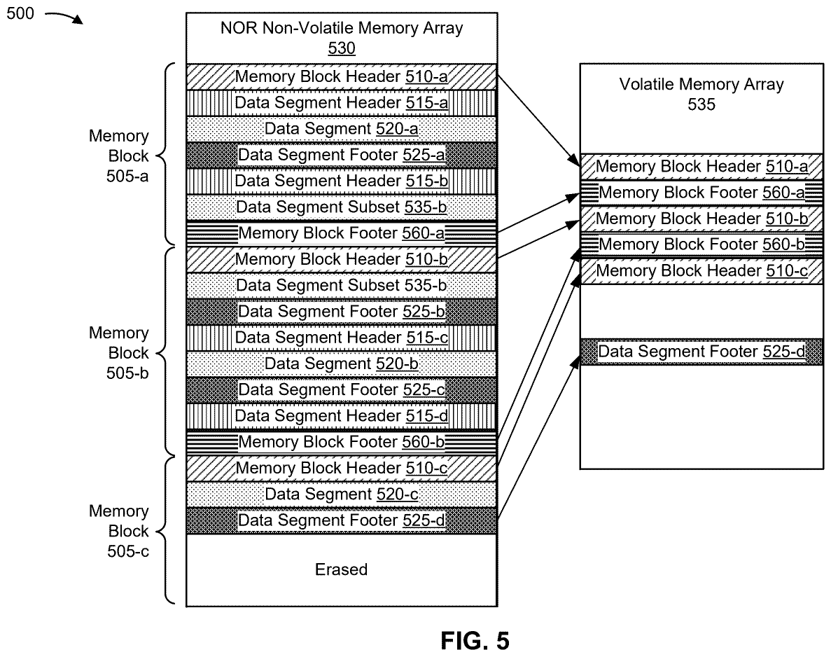

FIG. 5 is a diagram of an example 500 of event log data storage. The operations described in connection with FIG. 5 may be performed by the memory system 110 and/or one or more components of the memory system 110, such as the memory system controller 115, one or more memory devices 120, and/or one or more local controllers 125. The NOR non-volatile memory array 530 may include aspects of the non-volatile memory arrays 130, the NOR non-volatile memory array 330, and the NOR non-volatile memory array 430; and the volatile memory array 535 may include aspects of the memory array(s) 135 and the volatile memory array 335.

The example 500 illustrates an example mount operation performed by a memory system. In particular, the example 500 illustrates the memory system transferring log data from the NOR non-volatile memory array 530 to the volatile memory array 535. In some cases, the example 500 may illustrate the memory system mounting a log data file from a set of memory blocks (such as the set of memory blocks 355 or the set of memory blocks 455, as described with reference to FIGS. 3 and 4, respectively). The memory system may perform the mount operation to identify one or more parameters associated with the log file, which may enable the memory system to write new event log data to the one or more memory blocks 505 that are configured to store the log file. For example, the memory system may perform the mount operation to identify a read pointer associated with the log file, a write pointer associated with the log file, a size of the log file, a next available address associated with the log file, or another parameter associated with the log file.

To perform the mount operation, the memory system may transfer the memory block headers 510 and the memory block footers 560 from each memory block 505 in the set of memory blocks. For example, the memory system may read the memory block headers 510 and the memory block footers 560 from the NOR non-volatile memory array 530, and write the memory block headers 510 and the memory block footers 560 to the volatile memory array 535 (such as to RAM in the memory system). In the example 500, the memory system may transfer the memory block header 510-a, the memory block footer 560-a, the memory block header 510-b, the memory block footer 560-b, and the memory block header 510-c from the NOR non-volatile memory array 530 to the volatile memory array 535 as part of the mount operation.

The memory system may identify a currently open memory block 505 from the set of memory blocks based on reading one or more of the memory block headers 510 and one or more of the memory block footers 560 stored in the set of memory blocks. In particular, the memory system may identify the currently open memory block 505 as the memory block 505 having a valid memory block header 510-a and an invalid memory block footer 560. In the example 500, the memory system may identify that the memory block 505-c is the currently open memory block 505 in response to the memory block 505-c having the valid memory block header 510-c and not having any valid memory block footer 560. If all block headers and footers are valid, then the memory system may identify the currently open block as the memory block 505 with the highest block sequence number.

The memory system may read each of the data segment headers 515 and the data segment footers 525 from the memory block 505 identified as the currently open memory block 505. For example, the memory system may read the data segment footer 525-d from the memory block 505-c based on identifying that the memory block 505-c is the currently open memory block 505. The memory system may identify the next available address associated with the set of memory blocks (e.g., and the log file) based on the data segment headers 515 and/or the data segment footers 525 transferred from the NOR non-volatile memory array 530 to the volatile memory array 535. For example, the memory system may determine a current open block offset parameter (e.g., indicative of the next available address) for a memory block 505 based on detecting an erased area within a memory block 505 after a last data segment footer 525 in the memory block 505. For example, the memory system may identify that the address after the data segment footer 525-d in the memory block 505-c corresponds to the next available address based on the memory block 505-c including an erased area after the data segment footer 525-d. In some cases, the memory system may detect the erased area within a memory block 505 using an erased area detection (e.g., by detecting portions of the memory block 505 that are storing data associated with a value of ‘0xFF’, which may be indicative of those portions of the memory block 505 being erased).

The example 500 may illustrate a mount operation that uses fewer resources within the volatile memory array 535 as compared to a mount operation for an event log data file that does not include memory block headers 510, memory block footers 560, data segment headers 515, and/or data segment footers 525. That is, transferring the memory block headers 510, memory block footers 560, data segment headers 515, and data segment footers 525 to the volatile memory array 535 may use less resources in the volatile memory array 535 as compared to transferring each of the data segments 520 within the event log data file. For example, a memory block header 510 may include 16 bytes of data, a memory block footer 560 may include 10 bytes of data, a data segment header 515 may include 14 bytes of data, a data segment footer may include 18 bytes of data, and a data segment 520 may include up to 64 kilobytes of data. Accordingly, storing multiple memory block headers 510, memory block footers 560, data segment headers 515, and data segment footers 525 may utilize fewer resources than storing even a single data segment 520.

As indicated above, FIG. 5 is provided as an example. Other examples may differ from what is described with regard to FIG. 5.

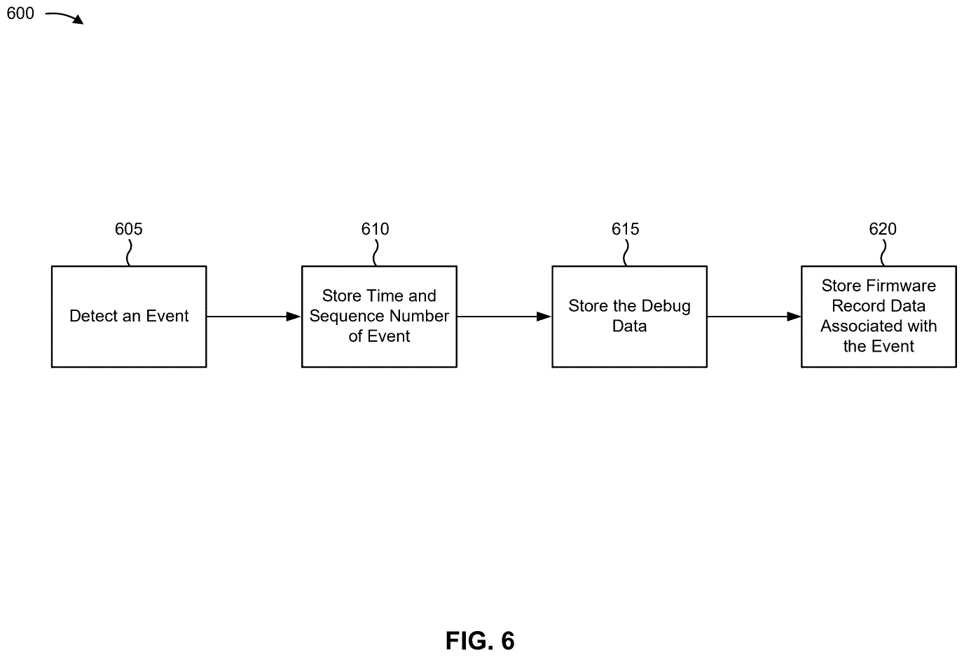

FIG. 6 is a diagram of an example process 600 related to event log data storage. The operations described in connection with FIG. 6 may be performed by a memory system (such as the memory system 110, the CXL compliant memory system 204, the memory system 310) and/or one or more components of the memory system, such as the memory system controller 115, one or more memory devices 120, the one or more local controllers 125, and/or the one or more CPUs 325. The example process 600 may illustrate one or more operations associated with writing new data to an event log data file, as described with reference to FIGS. 3 through 5. For example, the process 600 may include the memory system storing event log data within a NOR non-volatile memory array, such as the NOR non-volatile memory array 330, the NOR non-volatile memory array 430, and/or the NOR non-volatile memory array 530.

At 605, the memory system may detect an event associated with operating the memory system. For example, the memory system may detect a CXL device vendor specific warning, error, or critical event occurring at the memory system. In response to detecting the event, the memory system may determine to store log data associated with the event in a NOR non-volatile memory array of the memory system.

At 610, the memory system may store a first portion of the log data that is indicative of a time and sequence number associated with the event in a first set of memory blocks in the NOR non-volatile memory array. For example, the memory system may store the first portion of the log data in a set of memory blocks that is configured to store an event log data file of global firmware event times and sequence numbers. In some cases, the set of memory blocks that is configured to store the event log data file of the global firmware event times and sequence numbers may correspond to the set of memory blocks 355-c or the set of memory blocks 455-c, as described with reference to FIGS. 3 and 4, respectively.

At 615, the memory system may store the debug data within the NOR non-volatile memory array. For example, the memory system may store the debug data associated with the event, along with the debug data sequence number, and a debug data source identifier in the second set of memory blocks in the NOR non-volatile memory array (e.g., the set of memory blocks that are configured to store the event log data file that includes debug data).

At 620, the memory system may store log data including firmware record data associated with the event in the NOR non-volatile memory array. For example, the memory system may store the firmware record data in a third set of memory blocks in the NOR non-volatile memory array. In some cases, the set of memory blocks that is configured to store the firmware record data may correspond to the set of memory blocks 355-a or the set of memory blocks 455-a, as described with reference to FIGS. 3 and 4, respectively. The memory system may store the firmware record data in an event log data file that is associated with a type of the event that is detected. For example, the NOR non-volatile memory array may store a first event log data file associated with warning events, a second event log data file associated with error events, and a third event log data file associated with critical events. The memory system may store, in the log data that includes the firmware record data, a reference link indicative of the debug data associated with the event. For example, the memory system may store the debug data sequence number and the debug data source identifier in the firmware record data associated with the event, which may indicate the link to the debug data (e.g., stored in the second set of memory blocks in the NOR non-volatile memory array) that includes the same debug data sequence number and debug data source identifier.

As indicated above, FIG. 6 is provided as an example. Other examples may differ from what is described with regard to FIG. 6.

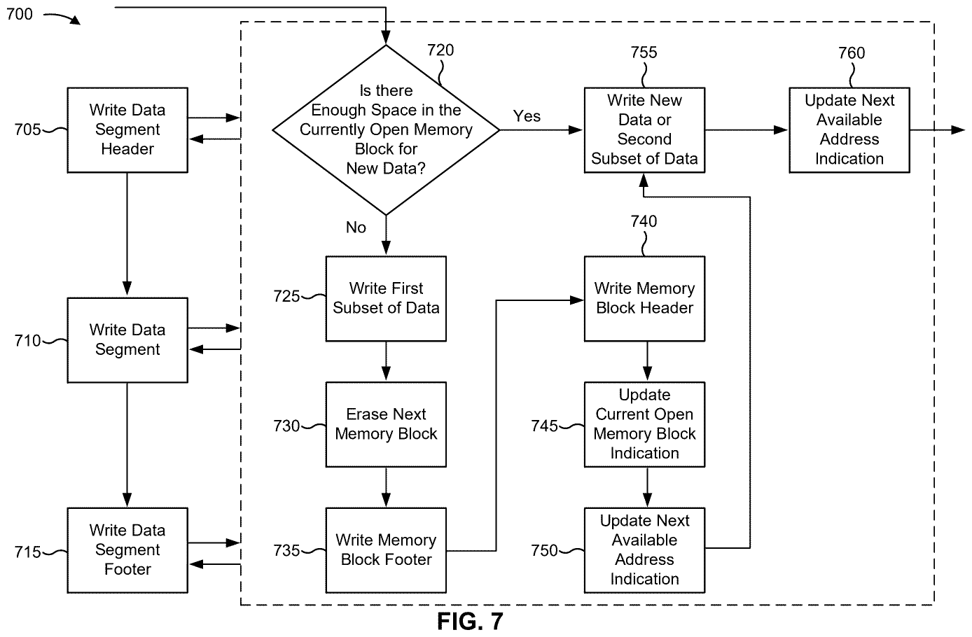

FIG. 7 is a diagram of an example process 700 related to event log data storage. The operations described in connection with FIG. 7 may be performed by a memory system (such as the memory system 110, the CXL compliant memory system 204, the memory system 310) and/or one or more components of the memory system, such as the memory system controller 115, one or more memory devices 120, the one or more local controllers 125, and/or the one or more CPUs 325.

The example process 700 may illustrate one or more operations associated with writing new data to an event log data file, as described with reference to FIGS. 3 through 6. For example, the process 700 may include the memory system storing event log data within a NOR non-volatile memory array, such as the NOR non-volatile memory array 330, the NOR non-volatile memory array 430, and/or the NOR non-volatile memory array 530. In some cases, the memory system may perform the process 700 to store the time and sequence number of an event (e.g., as described with reference to 610 in the process 600), to store the debug data associated with an event (e.g., as described with reference to 615 in the process 600), and to store the firmware record data associated with the event (e.g., as described with reference to 620 in the process 600).

A memory system may identify log data (e.g., associated with a detected event) to store within a set of memory blocks (e.g., within a set of contiguous memory blocks) in a NOR non-volatile memory array. In one example, the log data may include an indication of time associated with an event and an indication of a sequence number associated with the event (e.g., may correspond to global firmware event times and sequence number log data). In another example, the log data may include debug data associated with the event (e.g., may correspond to debug data source log data). In another example, the log data may include firmware record data associated with the event (e.g., may correspond to firmware event log data). As described herein, the memory system may store the log data within a data segment (e.g., a data segment 420, a data segment 520), and may additionally store a data segment header (e.g., a data segment header 415, a data segment header 515) and a data segment footer (e.g., a data segment footer 425, a data segment footer 525) in the set of memory blocks of the NOR non-volatile memory array.

At 705, the memory system may write the data segment header to a memory block. In particular, the memory system may write the data segment header to the memory block within the set of memory blocks that is indicated as the current open memory block. Additionally, the memory system may write the data segment header to an address within the currently open memory block that is indicated by a next available address indication. In some cases, the memory system may proceed to block 720 in order to write the data segment header to the memory block. That is, the memory system may perform the operations at 720, 725, 730, 735, 740, 745, 750, 755, and/or 760 to write the data segment header to the memory block.

At 710, the memory system may write the data segment to the memory block. In particular, the memory system may write the data segment to the memory block within the set of memory blocks that is indicated as the current open memory block. Additionally, the memory system may write the data segment to an address within the currently open memory block that is indicated by a next available address indication. In particular, the memory system may write the data segment to the memory block within the set of memory blocks that is indicated as the current open memory block. In some cases, the memory system may proceed to block 720 in order to write the data segment to the memory block. That is, the memory system may perform the operations at 720, 725, 730, 735, 740, 745, 750, 755, and/or 760 to write the data segment header to the memory block.

At 715, the memory system may write a data segment footer to the memory block. In particular, the memory system may write the data segment footer to the memory block within the set of memory blocks that is indicated as the current open memory block. In some cases, the currently open memory block may be indicated by a current open block index associated with the set of memory blocks. Additionally, the memory system may write the data segment footer to an address within the currently open memory block that is indicated by a next available address indication. The next available address indication may correspond to a current open block offset pointer associated with the set of memory blocks. In some cases, the memory system may proceed to block 720 in order to write the data segment footer to the memory block. That is, the memory system may perform the operations at 720, 725, 730, 735, 740, 745, 750, 755, and/or 760 to write the data segment footer to the memory block.

In some cases, by writing the data segment header, then writing the data segment, then writing the data segment footer to the set of memory blocks in the NOR non-volatile memory array, the memory system may identify if a power cycle occurs in the middle of the writing of the event log data to the NOR non-volatile memory array (e.g., and interrupts the writing of the event log data). For example, the memory system may identify that the write sequence may have been interrupted (e.g., by a sudden unexpected power cycle that occurs in the middle of the write sequence) based on the contents within the data segment header, the data segment footer, or both. In one example, the memory system may perform a mount sequence for the event log data file and identify that the write sequence was interrupted in response to identifying that a data segment header includes invalid error detection information (e.g., includes an invalid cyclic redundancy check information) but is not erased (e.g., does not include all ‘0xFF’ values). In another example, the memory system may perform a mount sequence for the event log data file and identify that the write sequence was interrupted in response to identifying that the data segment header includes valid error detection information (e.g., includes a valid cyclic redundancy check information) and that the data segment footer includes invalid error detection information (e.g., includes invalid cyclic redundancy check information) or is erased (e.g., includes all ‘0xFF’ values).

At 720, the memory system may determine whether there is enough space in the currently open memory block for the new data (e.g., for the data segment header, for the data segment, for the data segment footer). If the memory system determines that there is enough space in the currently open memory block for the new data, the memory system may proceed to 755. Additionally, if the memory system determines that there is not enough space in the currently open memory block for the new data, the memory system may proceed to 725.

At 725, the memory system may write a first subset of the data segment to the currently open memory block. For example, the memory system may divide the data segment into a first subset and a second subset based on the amount of space remaining in the currently open block.

At 730, the memory system may perform an erase operation on the next memory block in the set of memory blocks. For example, the memory system may erase the data stored in a subsequent memory block in the set of memory blocks. In another example where the currently open memory block is a last memory block in the set of memory blocks, the memory system may perform an erase operation on the first memory block in the set of memory blocks (e.g., based on the set of memory blocks within the NOR non-volatile memory array corresponding to a ring buffer data structure). In some cases, performing the erase operation on a memory block may include storing a value of ‘0xFF’ in each address of the next memory block. The memory system may increment an erase count associated with the memory block in response to performing the erase operation on the memory block.

At 735, the memory system may write a memory block footer in the currently open memory block. In some cases, writing the memory block footer in the currently open memory block may close the currently open memory block.

At 740, the memory system may write a memory block header to the next memory block (e.g., that was erased at 730). In some cases, writing the memory block header to the next memory block may open the next memory block.

At 745, the memory system may update the currently open memory block indication associated with the set of memory blocks. For example, the memory system may update the currently open memory block from indicating that a first memory block is the currently open memory block to indicating that a second memory block (e.g., the next memory block that is erased at 730) is the currently open memory block.

At 750, the memory system may update a next available address indication associated with the set of memory blocks. For example, the memory system may update the next available address indication to indicate an address that occurs after the memory block header of the currently open memory block.

At 755, the memory system may write the data to the address indicated by the next available address indication in the memory block indicated by the currently open memory block indication. If the memory system proceeds to 755 directly from 720, the memory system may write the new data at 755. Additionally, if the memory system proceeds to 755 from 750, the memory system may write the second subset of the data segment at 755.

At 760, the memory system may update the next available address indication associated with the set of memory blocks. For example, the memory system may update the next available address indication to point to an address that immediately follows the data written to the memory block at 755.

As indicated above, FIG. 7 is provided as an example. Other examples may differ from what is described with regard to FIG. 7.

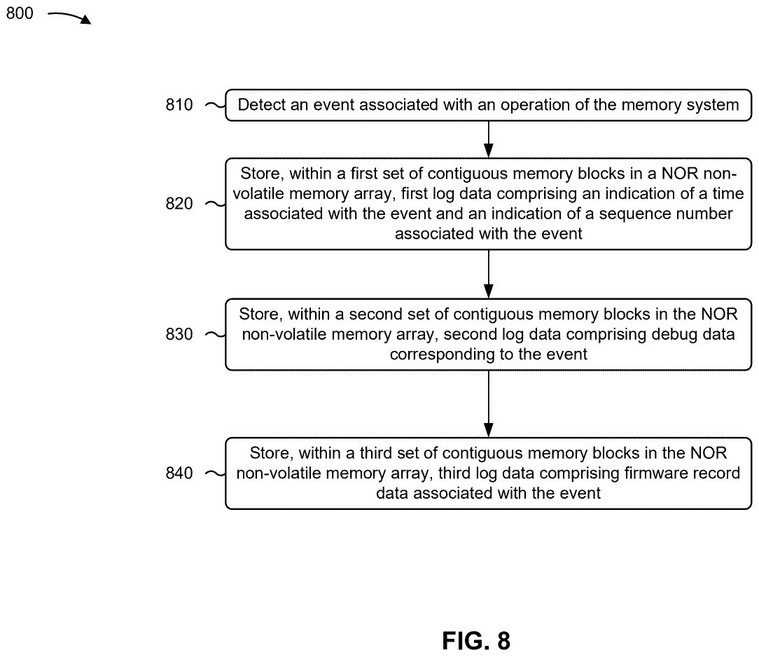

FIG. 8 is a flowchart of an example method 800 associated with event log data storage. In some implementations, a memory system (e.g., the memory system 110, the CXL compliant memory system 204, and/or the memory system 310) may perform or may be configured to perform the method 800. Additionally, or alternatively, one or more components of the memory system (e.g., the memory system controller 115, and/or the CPUs 325) may perform or may be configured to perform the method 800. Thus, means for performing the method 800 may include the memory system and/or one or more components of the memory system. Additionally, or alternatively, a non-transitory computer-readable medium may store one or more instructions that, when executed by the memory system, cause the memory system to perform the method 800.

As shown in FIG. 8, the method 800 may include detecting an event associated with an operation of the memory system (block 810). As further shown in FIG. 8, the method 800 may include storing, within a first set of contiguous memory blocks in a NOR non-volatile memory array, first log data comprising an indication of a time associated with the event and an indication of a sequence number associated with the event (block 820). As further shown in FIG. 8, the method 800 may include storing, within a second set of contiguous memory blocks in the NOR non-volatile memory array, second log data comprising debug data corresponding to the event (block 830). As further shown in FIG. 8, the method 800 may include storing, within a third set of contiguous memory blocks in the NOR non-volatile memory array, third log data comprising firmware record data associated with the event (block 840).

The method 800 may include additional aspects, such as any single aspect or any combination of aspects described below and/or described in connection with one or more other methods or operations described elsewhere herein.

In a first aspect, to store data comprising the first log data, the second log data, or the third log data, the method 800 includes determining that a first size of available space in a first memory block that is open within a set of contiguous memory blocks is less than a second size of the data, wherein the set of contiguous memory blocks is the first set of contiguous memory blocks, the second set of contiguous memory blocks, or the third set of contiguous memory blocks; storing a first subset of the data in the first memory block within the set of contiguous memory blocks; writing a memory block footer in the first memory block to close the first memory block based at least in part on the determining; writing a memory block header in a second memory block within the set of contiguous memory blocks to open the second memory block based at least in part on closing the first memory block; and storing a second subset of the data in the second memory block within the set of contiguous memory blocks based at least in part on opening the second memory block.

In a second aspect, alone or in combination with the first aspect, the method 800 includes performing an erase operation on the second memory block based at least in part on closing the first memory block, wherein writing the memory block header in the second memory block is based at least in part on performing the erase operation on the second memory block.

In a third aspect, alone or in combination with one or more of the first and second aspects, the method 800 includes incrementing a quantity of erase operations indicated within the memory block header based at least in part on performing the erase operation.

In a fourth aspect, alone or in combination with one or more of the first through third aspects, the method 800 includes updating a current open memory block indication associated with the set of memory blocks to be indicative of the second memory block based at least in part on writing the memory block header in the second memory block, and updating a next available address indication associated with the set of contiguous memory blocks based at least in part on writing the memory block header in the second memory block, wherein storing the second subset of the data comprises storing at least a portion of the second subset of the data at an address indicated by the next available address indication.

In a fifth aspect, alone or in combination with one or more of the first through fourth aspects, the memory block header in the second memory block comprises an indication of a quantity of erase operations performed on the second memory block, an indication of error detection information associated with memory block header, or both.

In a sixth aspect, alone or in combination with one or more of the first through fifth aspects, to store data comprising the first log data, the second log data, or the third log data, the method 800 includes determining that a first size of available space in a first memory block that is open within a set of contiguous memory blocks is greater than a second size of the data, wherein the set of contiguous memory blocks is the first set of contiguous memory blocks, the second set of contiguous memory blocks, or the third set of contiguous memory blocks, and storing the data in the first memory block based at least in part on the determining.

In a seventh aspect, alone or in combination with one or more of the first through sixth aspects, the method 800 includes storing the data in the first memory block without performing an erase operation on the first memory block based at least in part on the determining.

In an eighth aspect, alone or in combination with one or more of the first through seventh aspects, to store data comprising the first log data, the second log data, or the third log data, the method 800 includes writing a data segment header associated with the event to a first address in a set of contiguous memory blocks that is indicated by a next available address indication associated with the set of contiguous memory blocks, wherein the set of contiguous memory blocks is the first set of contiguous memory blocks, the second set of contiguous memory blocks, or the third set of contiguous memory blocks, updating the next available address indication based at least in part on writing the data segment header to the first address, writing the data to a second address in the set of contiguous memory blocks that is indicated by the next available address indication, updating the next available address indication based at least in part on writing the data to the second address, writing a data segment footer associated with the event to a third address in the set of contiguous memory blocks that is indicated by the next available address indication, and updating the next available address indication based at least in part on writing the data segment footer to the third address.

In a ninth aspect, alone or in combination with one or more of the first through eighth aspects, the data segment header comprises one or more of the sequence number associated with the event, an indication of a size of the data, first error detection information associated with the data segment header and the data, and second error detection information associated with the data segment header and not associated with the data.

In a tenth aspect, alone or in combination with one or more of the first through ninth aspects, the data segment footer comprises one or more of the indication of the time associated with the event and error detection information associated with the data segment footer.

In an eleventh aspect, alone or in combination with one or more of the first through tenth aspects, the method 800 includes determining whether the second set of contiguous memory blocks is currently storing the debug data based at least in part on an identifier of a source associated with the debug data and a sequence number associated with the debug data.

In a twelfth aspect, alone or in combination with one or more of the first through eleventh aspects, the first set of contiguous memory blocks is configured to store log data associated with warning events, error events, and critical events.

In a thirteenth aspect, alone or in combination with one or more of the first through twelfth aspects, the third set of contiguous blocks is configured to store log data associated with warning events, error events, or critical events.

In a fourteenth aspect, alone or in combination with one or more of the first through thirteenth aspects, the third log data further comprises one or more of an identifier of the firmware record data associated with the event, an identifier of a source associated with the debug data, or a sequence number associated with the debug data.

In a fifteenth aspect, alone or in combination with one or more of the first through fourteenth aspects, the sequence number associated with the event is a global sequence number indicative of an order of the event with respect to one or more previously occurring events.

In a sixteenth aspect, alone or in combination with one or more of the first through fifteenth aspects, the memory system is a CXL compliant memory system.

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein.

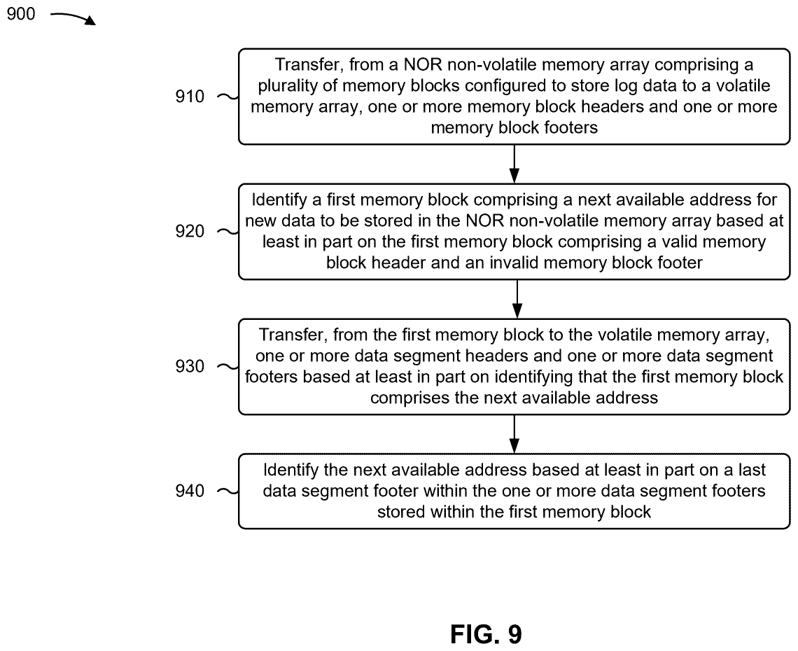

FIG. 9 is a flowchart of an example method 900 associated with event log data storage. In some implementations, a memory system (e.g., the memory system 110, the CXL compliant memory system 204, and/or the memory system 310) may perform or may be configured to perform the method 900. Additionally, or alternatively, one or more components of the memory system (e.g., the memory system controller 115, and/or the CPUs 325) may perform or may be configured to perform the method 900.

Thus, means for performing the method 900 may include the memory system and/or one or more components of the memory system. Additionally, or alternatively, a non-transitory computer-readable medium may store one or more instructions that, when executed by the memory system, cause the memory system to perform the method 900.

As shown in FIG. 9, the method 900 may include transferring, from a NOR non-volatile memory array comprising a plurality of memory blocks configured to store log data to a volatile memory array, one or more memory block headers and one or more memory block footers (block 910). As further shown in FIG. 9, the method 900 may include identifying a first memory block comprising a next available address for new data to be stored in the NOR non-volatile memory array based at least in part on the first memory block comprising a valid memory block header and an invalid memory block footer (block 920). As further shown in FIG. 9, the method 900 may include transferring, from the first memory block to the volatile memory array, one or more data segment headers and one or more data segment footers based at least in part on identifying that the first memory block comprises the next available address (block 930). As further shown in FIG. 9, the method 900 may include identifying the next available address based at least in part on a last data segment footer within the one or more data segment footers stored within the first memory block (block 940).

The method 900 may include additional aspects, such as any single aspect or any combination of aspects described below and/or described in connection with one or more other methods or operations described elsewhere herein.

In a first aspect, the method 900 includes updating a current open memory block indication to be indicative of the first memory block based at least in part on identifying that the first memory block comprises the next available address.

In a second aspect, alone or in combination with the first aspect, the method 900 includes updating a next available address indication to be indicative of the next available address based at least in part on identifying the next available address.

In a third aspect, alone or in combination with one or more of the first and second aspects, each memory block header of the one or more memory block headers comprises an indication of a quantity of erase operations performed on a corresponding memory block, an indication of error detection information associated with memory block header, or both.

In a fourth aspect, alone or in combination with one or more of the first through third aspects, each data segment header of the one or more data segment headers comprises a global sequence number associated with an event, an indication of a size of a corresponding data segment, first error detection information associated with the data segment header and the corresponding data segment, and second error detection information associated with the data segment header and not associated with the corresponding data segment.

In a fifth aspect, alone or in combination with one or more of the first through fourth aspects, the plurality of memory blocks are configured to store first log data comprising an indication of a time associated with an event and a global sequence number associated with the event, second log data comprising debug data corresponding to the event, or third log data comprising firmware record data associated with the event.

In a sixth aspect, alone or in combination with one or more of the first through fifth aspects, the memory system is a CXL compliant memory system.

Although FIG. 9 shows example blocks of a method 900, in some implementations, the method 900 may include additional blocks, fewer blocks, different blocks, or differently arranged blocks than those depicted in FIG. 9. Additionally, or alternatively, two or more of the blocks of the method 900 may be performed in parallel. The method 900 is an example of one method that may be performed by one or more devices described herein. These one or more devices may perform or may be configured to perform one or more other methods based on operations described herein.

In some implementations, a memory system includes one or more components configured to: detect an event associated with an operation of the memory system; store, within a first set of contiguous memory blocks in a NOR non-volatile memory array, first log data comprising an indication of a time associated with the event and an indication of a sequence number associated with the event; store, within a second set of contiguous memory blocks in the NOR non-volatile memory array, second log data comprising debug data corresponding to the event; and store, within a third set of contiguous memory blocks in the NOR non-volatile memory array, third log data comprising firmware record data associated with the event.

In some implementations, a memory system includes one or more components configured to: transfer, from a NOR non-volatile memory array comprising a plurality of memory blocks configured to store log data to a volatile memory array, one or more memory block headers and one or more memory block footers; identify a first memory block comprising a next available address for new data to be stored in the NOR non-volatile memory array based at least in part on the first memory block comprising a valid memory block header and an invalid memory block footer; transfer, from the first memory block to the volatile memory array, one or more data segment headers and one or more data segment footers based at least in part on identifying that the first memory block comprises the next available address; and identify the next available address based at least in part on a last data segment footer within the one or more data segment footers stored within the first memory block.

In some implementations, a memory system comprising: a controller configured to detect a plurality of events associated with an operation of the memory system; and a NOR non-volatile memory array coupled to the controller and comprising: a first set of contiguous memory blocks configured to store first log data comprising indications of times associated with each of the plurality of events and sequence numbers associated with each of the plurality of events.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
detect an event associated with an operation of the memory system;
store, within a first set of contiguous memory blocks in a NOR non-volatile memory array, first log data comprising an indication of a time associated with the event and an indication of a sequence number associated with the event;
store, within a second set of contiguous memory blocks in the NOR non-volatile memory array, second log data comprising debug data corresponding to the event; and
store, within a third set of contiguous memory blocks in the NOR non-volatile memory array, third log data comprising firmware record data associated with the event.

2. The memory system of claim 1, wherein the one or more components configured to store data comprising the first log data, the second log data, or the third log data, are further configured to:
determine that a first size of available space in a first memory block that is open within a set of contiguous memory blocks is less than a second size of the data, wherein the set of contiguous memory blocks is the first set of contiguous memory blocks, the second set of contiguous memory blocks, or the third set of contiguous memory blocks;
store a first subset of the data in the first memory block within the set of contiguous memory blocks;
write a memory block footer in the first memory block to close the first memory block based at least in part on the determining;
write a memory block header in a second memory block within the set of contiguous memory blocks to open the second memory block based at least in part on closing the first memory block; and
store a second subset of the data in the second memory block within the set of contiguous memory blocks based at least in part on opening the second memory block.

3. The memory system of claim 2, wherein the one or more components are further configured to:
perform an erase operation on the second memory block based at least in part on closing the first memory block, wherein writing the memory block header in the second memory block is based at least in part on performing the erase operation on the second memory block.

4. The memory system of claim 3, wherein the one or more components are further configured to increment a quantity of erase operations indicated within the memory block header based at least in part on performing the erase operation.

5. The memory system of claim 2, wherein the one or more components are further configured to:
update a current open memory block indication associated with the set of memory blocks to be indicative of the second memory block based at least in part on writing the memory block header in the second memory block; and
update a next available address indication associated with the set of contiguous memory blocks based at least in part on writing the memory block header in the second memory block, wherein storing the second subset of the data comprises storing at least a portion of the second subset of the data at an address indicated by the next available address indication.

6. The memory system of claim 2, wherein the memory block header in the second memory block comprises an indication of a quantity of erase operations performed on the second memory block, an indication of error detection information associated with memory block header, or both.

7. The memory system of claim 1, wherein the one or more components configured to store data comprising the first log data, the second log data, or the third log data, are further configured to:
determine that a first size of available space in a first memory block that is open within a set of contiguous memory blocks is greater than a second size of the data, wherein the set of contiguous memory blocks is the first set of contiguous memory blocks, the second set of contiguous memory blocks, or the third set of contiguous memory blocks; and
store the data in the first memory block based at least in part on the determining.

8. The memory system of claim 7, wherein the one or more components are further configured to store the data in the first memory block without performing an erase operation on the first memory block based at least in part on the determining.

9. The memory system of claim 1, wherein the one or more components configured to store data comprising the first log data, the second log data, or the third log data, are further configured to:
write a data segment header associated with the event to a first address in a set of contiguous memory blocks that is indicated by a next available address indication associated with the set of contiguous memory blocks, wherein the set of contiguous memory blocks is the first set of contiguous memory blocks, the second set of contiguous memory blocks, or the third set of contiguous memory blocks;
update the next available address indication based at least in part on writing the data segment header to the first address;
write the data to a second address in the set of contiguous memory blocks that is indicated by the next available address indication;
update the next available address indication based at least in part on writing the data to the second address;
write a data segment footer associated with the event to a third address in the set of contiguous memory blocks that is indicated by the next available address indication; and
update the next available address indication based at least in part on writing the data segment footer to the third address.

10. The memory system of claim 9, wherein the data segment header comprises one or more of the sequence number associated with the event, an indication of a size of the data, first error detection information associated with the data segment header and the data, and second error detection information associated with the data segment header and not associated with the data.

11. The memory system of claim 9, wherein the data segment footer comprises one or more of the indication of the time associated with the event and error detection information associated with the data segment footer.

12. The memory system of claim 1, wherein the first set of contiguous memory blocks is configured to store log data associated with warning events, error events, and critical events.

13. The memory system of claim 1, wherein the third set of contiguous blocks is configured to store log data associated with warning events, error events, or critical events.

14. The memory system of claim 1, wherein the third log data further comprises one or more of an identifier of the firmware record data associated with the event, an identifier of a source associated with the debug data, or a sequence number associated with the debug data.

15. The memory system of claim 1, wherein the sequence number associated with the event is a global sequence number indicative of an order of the event with respect to one or more previously occurring events.

16. The memory system of claim 1, wherein the memory system is a compute express link (CXL) compliant memory system.

17. A memory system, comprising:
one or more components configured to:
transfer, from a NOR non-volatile memory array comprising a plurality of memory blocks configured to store log data to a volatile memory array, one or more memory block headers and one or more memory block footers;
identify a first memory block comprising a next available address for new data to be stored in the NOR non-volatile memory array based at least in part on the first memory block comprising a valid memory block header and an invalid memory block footer;
transfer, from the first memory block to the volatile memory array, one or more data segment headers and one or more data segment footers based at least in part on identifying that the first memory block comprises the next available address; and
identify the next available address based at least in part on a last data segment footer within the one or more data segment footers stored within the first memory block.

18. The memory system of claim 17, wherein the one or more components are further configured to:
update a current open memory block indication to be indicative of the first memory block based at least in part on identifying that the first memory block comprises the next available address.

19. The memory system of claim 17, wherein the one or more components are further configured to:
update a next available address indication to be indicative of the next available address based at least in part on identifying the next available address.

20. The memory system of claim 17, wherein each memory block header of the one or more memory block headers comprises an indication of a quantity of erase operations performed on a corresponding memory block, an indication of error detection information associated with memory block header, or both.

21. The memory system of claim 17, wherein each data segment header of the one or more data segment headers comprises a global sequence number associated with an event, an indication of a size of a corresponding data segment, first error detection information associated with the data segment header and the corresponding data segment, and second error detection information associated with the data segment header and not associated with the corresponding data segment.

22. The memory system of claim 21, wherein the plurality of memory blocks are configured to store first log data comprising an indication of a time associated with an event and a global sequence number associated with the event, second log data comprising debug data corresponding to the event, or third log data comprising firmware record data associated with the event.

23. The memory system of claim 17, wherein the memory system is a compute express link (CXL) compliant memory system.

24. A memory system comprising:
a controller configured to detect a plurality of events associated with an operation of the memory system; and
a NOR non-volatile memory array coupled to the controller and comprising:
a first set of contiguous memory blocks configured to store first log data comprising indications of times associated with each of the plurality of events and sequence numbers associated with each of the plurality of events.
a second set of contiguous memory blocks configured to store second log data comprising debug data corresponding to each of the plurality of events; and
a third set of contiguous memory blocks configured to store third log data comprising firmware record data associated with each of the plurality of events.

25. The memory system of claim 24, further comprising:
a volatile memory array coupled to the controller and the NOR non-volatile memory array, wherein the controller is further configured to:
transfer, from the first set of contiguous memory blocks of the NOR non-volatile memory array to the volatile memory array, the first log data; and
identify a time and a sequence number associated with a first event, from the plurality of events, that occurred more recently than a remaining quantity of events in the plurality of events.

26. The memory system of claim 25, wherein the controller identifies the first event as occurring more recently than the remaining quantity of events based at least in part on the sequence number associated with the first event being higher than sequence numbers associated with the remaining quantity of events, the time associated with the first event being more recent than times associated with the remaining quantity of events, or both.

27. The memory system of claim 24, wherein each memory block within the first set of contiguous memory blocks, the second set of contiguous memory blocks, and the third set of memory blocks that is storing log data comprises a memory block header.

28. The memory system of claim 27, wherein the memory block header comprises an indication of a quantity of erase operations performed on a corresponding memory block, an indication of error detection information associated with memory block header, or both.

29. A method performed by a memory system, comprising:
detecting an event associated with an operation of the memory system;
storing, within a first set of contiguous memory blocks in a NOR non-volatile memory array, first log data comprising an indication of a time associated with the event and an indication of a sequence number associated with the event;
storing, within a second set of contiguous memory blocks in the NOR non-volatile memory array, second log data comprising debug data corresponding to the event; and
storing, within a third set of contiguous memory blocks in the NOR non-volatile memory array, third log data comprising firmware record data associated with the event.

30. The method of claim 29, wherein storing data comprising the first log data, the second log data, or the third log data, comprises:
determining that a first size of available space in a first memory block that is open within a set of contiguous memory blocks is less than a second size of the data, wherein the set of contiguous memory blocks is the first set of contiguous memory blocks, the second set of contiguous memory blocks, or the third set of contiguous memory blocks;
storing a first subset of the data in the first memory block within the set of contiguous memory blocks;
writing a memory block footer in the first memory block to close the first memory block based at least in part on the determining;
writing a memory block header in a second memory block within the set of contiguous memory blocks to open the second memory block based at least in part on closing the first memory block; and
storing a second subset of the data in the second memory block within the set of contiguous memory blocks based at least in part on opening the second memory block.

31. A method performed by a memory system, comprising:
transferring, from a NOR non-volatile memory array comprising a plurality of memory blocks configured to store log data to a volatile memory array, one or more memory block headers and one or more memory block footers;
identifying a first memory block comprising a next available address for new data to be stored in the NOR non-volatile memory array based at least in part on the first memory block comprising a valid memory block header and an invalid memory block footer;
transferring, from the first memory block to the volatile memory array, one or more data segment headers and one or more data segment footers based at least in part on identifying that the first memory block comprises the next available address; and
identifying the next available address based at least in part on a last data segment footer within the one or more data segment footers stored within the first memory block.
